(19) United States
(12) Patent Application Publication
(10) Pub. No.: US 2008/0161434 A1
(43) Pub. Date: Jul. 3, 2008

(54) Novel polyisocyanurate foam materials

(76) Inventors: Duane Paradis, Highlands Ranch, CO (US); Mandy Schweitzer, Westminster, CO (US); Paul Hauge, Littleton, CO (US); Malay Nandi, Littleton, CO (US); Gaurav Agrawal, Aurora, CO (US)

Correspondence Address: JOHNS MANVILLE, 10100 WEST UTE AVENUE, PO BOX 625005, LITTLETON, CO, 80162-5005, US

(21) Appl. No.: 11/648,474

(22) Filed: Dec. 28, 2006

(51) Int. Cl. C08G 18/08; C08J 9/00

(52) U.S. Cl. 521/76; 521/122

(57) ABSTRACT

Provided is a novel foam composition for preparing polyisocyanurate foam. The composition comprises an isocyanate reactive compound, poyisocyanate, blowing agent and talc filler component. The talc filler is loaded from 0.5 to 20 wt % based on the isocyanate reaction compound, preferably a polyol, and the average particle size of the filler is in the range of from 7μ to 20μ. The foam material prepared contains a high loading of filler, yet still exhibits excellent foam properties.

### BACKGROUND OF THE INVENTION

1. Field of the Invention

This invention relates to rigid closed cell polyisocyanurate foam containing inorganic filler talc. The present invention also relates to a polyisocyanurate foam composition comprising isocyanate reactive compounds, polyisocyanates, blowing agents, and talc. More particularly, the present invention relates to the effect of the talc particle size on the polyisocyanurate foam properties.

2. Description of the Related Art

The manufacture of flexible faced, rigid polyisocyanurate foam insulation boardstock is commonly practiced by a process called restrained rise lamination. The restrained rise process relies on a combination of chemical component blending, precision metering, reactive component mixing and dispensing, use of a moving opposed platen pressure laminator, and use of dimensioning finishing equipment.

In the traditional restrained rise process, isocyanate (“Component A”) is used as received. Component A is supplied by pump to a metering unit, or a metering pump. A premix (“Component B”) containing polyol, expansion agent, catalyst and surfactant is prepared according to a defined formulation in a mix tank. Component B is also supplied by pump to a metering unit, or a metering pump. The metering pumps boost the pressure generally to 2000 to 2500 psi and control the flow of Components A and B to a precise ratio as determined by the desired chemistry. The pumps deliver Components A and B to at least one foam mixhead. Inside the mixhead, the Components A and B are impinged against each other at high pressure, which results in intimate mixing of the components.

The mixed chemicals exit the mixhead and are dispensed onto a moving bottom facing sheet in a plurality of discrete, liquid streams, in a quantity depending on the type and thickness of desired final boardstock product. The facing sheet carrying the chemical streams then enters a pressure laminator. The spacing, or gap, between the top and bottom platens of the laminator is set to approximately the final desired thickness of boardstock. The laminator temperature is adjusted typically to about 120 to 150° F. to insure that no heat is lost from the reacting, exothermic chemical mix, and to insure that the facings adhere well to the rising foam.

The mixed chemicals begin to react in about 5 to 10 seconds following mixing, expanding about 35 to 40 times in volume in the laminator and completing reaction in about 35 to 45 seconds. Laminator speed is adjusted to insure that complete reaction occurs within the pressure section of the laminator. The reaction rate is adjusted by catalyst modification to optimize chemical mixture “flow.” Flow is a property of the reacting, rising foam by which expansion is controlled in such a manner that the foam properly expands both upward and sideways to fully fill the moving cavity defined by the laminator. This reactivity adjustment is essential to control both the overall properties of the final product and the cost of manufacture. Improper flow results in poor foam cell geometry which can deteriorate physical, thermal and flammability properties, and causes excessive densification of foam layers in contact with facings.

Rigid boardstock, with facing firmly attached, exits the laminator. This boardstock is trimmed to the desired final width and length. Finished product is conveyed to packaging equipment.

Much of the art in the manufacture of foamed polyisocyanurate takes place where the mixed chemical streams are laid onto the bottom facer prior to entering the laminator. It is necessary that the chemical streams be placed and configured properly to insure that the potential negative effects of the rising foam (e.g., densification of foam at the facer interface through sideways expansion) are minimized. Proper chemical system catalysis is also essential to insure that the rising foam flows properly. Process line speed must be balanced with the foam reactivity so that flow is preserved and the finished boardstock has reached sufficient hardness to be further processed.

When done properly, acceptable foam physical, thermal and flammability properties are achieved. The density spread between core foam density and the in-place density, or IPD, is minimized (core foam density is defined as the measured density of the foam section of one half the thickness of the board taken from the center of the thickness; in-place density is defined as the total quantity of foam chemicals in a complete section of board including layers of surface densification and chemical that has been absorbed into the facers). Typical values for core foam density versus IPD for restrained rise process foam boardstock are 1.75 lb/ft³ for core foam density and 1.95 lb/ft³ for IPD. However, imbalance of laydown, catalyst and line speed can easily drive IPD well over 2.0 lb/ft³.

Typical maximum line speed for a restrained rise process is approximately 1.5 feet/min for each foot of laminator length. That is, a 70 foot long laminator will produce acceptable quality boardstock at 105 feet/min at minimal cost; a speed of 2.0 feet/min per foot of laminator can be achieved on certain products with catalyst modification and careful attention to operating parameters. It is advantageous to increase line speed, and therefore production capacities, to gain more output from a given piece of equipment.

While mechanical limitations (i.e., finishing saws, conveyors and packaging equipment) can be modified to accommodate higher line speeds by conventional means, maintenance of proper foam properties and cost efficiencies present a more difficult problem. Increased line speed reduces the laminator dwell time (the time that the reacting foam is inside the pressure laminator) and must be altered to complete foam reaction more quickly. As the reaction time is reduced, chemical flow is also altered resulting in a condition commonly known as “lock up.” When flow is lost, excessive densification at the foam/facer interface occurs, and cell geometry can be altered in a manner such that important properties, including compressive strength, dimensional stability, facer adhesion, insulation value and certain flammability characteristics, are deteriorated. It is therefore advantageous to remove or reduce the need for chemical flow as a component of the process.

Another known process for making flexible faced, rigid polyisocyanurate foam insulation boardstock is the free rise process. In this process, chemical laydown or distribution is accomplished through the use of a pair of matched, precision metering rolls. Chemicals are dispensed just upstream of the metering rolls. The gap between the rolls is adjusted to approximately 1/35 to 1/40 of the desired finished thickness of the boardstock. This small gap causes the dispensed chemical to form a “chemical bank” against the metering roll, forcing the chemical to spread across the full width of the bottom facer. A thin layer of mixed foam chemicals (approximately 1/35 to 1/40 of the desired finished thickness of the boardstock) is uniformly spread between the top and bottom facers. This composite then moves into a heated oven where the foam reaction is completed. Foam expands 35 to 40 times in volume and becomes sufficiently rigid for further processing. Final foam thickness is controlled by precision adjustment of the metering rolls. No mechanical restraint is utilized for thickness control, as with the restrained-rise process.

The free rise process does not require chemical flow. Dispensed and metered chemicals need only expand in the thickness dimension and not in the width dimension since the original laydown already accomplishes fall width application. By removing the need for flow, catalyst adjustments are made only to achieve complete reaction at the desired line speed without the negative impact of “locking up” the foam system. The free rise process is capable of speeds in excess of 250 feet/min.

An additional benefit of the free rise process is that density control is achieved within more efficient limits. Since sideways flow of expanding chemical does not occur, densification at the foam/facer interface is minimized. Density spreads of 1.70 lb/ft³ for core foam density and 1.75 lb/ft³ for IPD are routinely achieved.

The processing of polyisocyanurate foam materials has advanced such that excellent materials can now be prepared in an efficient manner. However, as with other polymeric material it is often desirable to reduce polymer content in foam by incorporating cheap inorganic filler to reduce the overall cost, but without necessarily sacrificing valuable properties. Inorganic fillers such as CaCO₃, talc, MgCO₃, mica have been used in cost reduction with minimum or no improvement or minimum sacrificing of overall polyisocyanurate foam properties, see, e.g., U.S. Pat. No. 5,891,563 and WO/96/20966. Incorporation of fly ash has increased the compressive strength see, U.S. Pat. No. 4,661,533. Nano sized functionalized clay is reported to increase foam properties at low loading, e.g., see WO 2006/060174 and WO 03/05981 7. As an example, carbon black is extensively used to increase the thermal insulation of foam at low percentage, see, e.g., U.S. Pat. No. 4,795,763, U.S. Pat. No. 5,137,930, U.S. Pat. No. 5,149,722, U.S. Pat. No. 5,373,026, U.S. Pat. No. 5,604,265, U.S. Pat. No. 5,192,607, and JP 57/147510. The presence of fillers such as Wollastonite, Aluminum trihydrate, chopped and continuous glass fiber is also reported in the literature, e.g., U.S. Pat. No. 4,680,214. A flexible polyurethane composition with fillers such as carbon black and silica of effective particle size (≦7μ) and pH range (7-8) is also reported in literature.

The problems associated with the incorporation of inorganic fillers CaCO₃, clay, silica, aluminum tri hydrate, mica, fly ash, wollastonite, feldspar, MgCO₃, ZnCO₃, carbon black, activated carbon, graphite, TIC₂, calcium metasilicate, glass fiber etc particularly in “rigid polyisocyanurate” foam is that they negatively effect the foam properties like cell rupture, compressive strength, friability, dispersion, etc, thus limiting its use in higher percentage. Ongoing interest exists in being able to incorporate a higher percentage of inorganic filler that eliminates partially or fully the negative effect on foam properties.

### SUMMARY OF THE INVENTION

Provided is a novel foam composition for preparing polyisocyanurate foam. The composition comprises an isocyanate reactive compound, poyisocyanate, blowing agent and talc filler component. The talc filler is loaded from 0.5 to 20 wt % based on the isocyanate reaction compound, preferably a polyol, and the average particle size of the filler is greater than the 7μ (average particle size) but less than 20μ (average particle size). The foam material prepared contains a high loading of filler, yet still exhibits excellent foam properties.

Among other factors, the present invention is based upon the discovery of the effect of filler talc particle size on the properties of polyisocyanurate foams. It has been found that by carefully selecting the talc particle size, generally within the range of from 7μ to 20μ, an actual improvement in properties, or at least a minimizing of the generally expected negative effect that a filler has on foam properties, such as friability at high filler loading, are observed.

### BRIEF DESCRIPTION OF THE FIGURES OF THE DRAWING

FIG. 1 graphically displays the effect of particle size and friability at 1 wt % in polyol.

FIG. 2 graphically displays the effect of particle size on the R value at 1 wt % in polyol.

FIG. 3 graphically displays the compressive strength to density ratio at high talc filler loadings.

FIG. 4 graphically displays the effect of the talc particle size for friability at high talc filler levels.

FIG. 5 graphically displays the R value for foams with high talc filler levels.

### DETAILED DESCRIPTION OF THE PREFERRED EMBODIMENT OF THE INVENTION

In the broadest aspects of the present invention, any organic polyisocyanate can be employed in the preparation of the rigid polyisocyanurate foams. The organic polyisocyanates which can be used include aromatic, aliphatic and cycloaliphatic polyisocyanates and combinations thereof. Such polyisocyanates are described, for example, in U.S. Pat. Nos. 4,795,763, 4,065,410, 3,401,180, 3,454,606, 3,152,162, 3,492,330, 3,001,973, 3,394,164 and 3,124,605, all of which are incorporated herein by reference.

Representative of the polyisocyanates are the diisocyanates such as m-phenylene diisocyanate, toluene-2,4-diisocyanate, toluene-2,6-diisocyanate, mixtures of 2,4- and 2,6-toluene diisocyanate, hexamethylene-1,6-diisocyanate, tetramethylene-1,4-diisocyanate, cyclohexane-1,4-diisocyanate, hexahydrotoluene 2,4- and 2,6-diisocyanate, naphthalene-1,5-diisocyanate, diphenyl methane-4,4′-diisocyanate, 4,4′-diphenylenediisocyanate, 3,3′-dimethoxy-4,4′-biphenyl-diisocyanate, 3,3′-dimethyldiphenylmethane-4,4′-diisocyanate; the triisocyanates such as 4,4′,4′-triphenylmethane-triisocyanate, polymethylenepolyphenyl isocyanate, toluene-2,4,6-triisocyanate; and the tetraisocyanates such as 4,4′-dimethyldiphenylmethane-2,2′,5,5′-tetraisocyanate.

Generally, suitable polyisocyanate includes aliphatic and aromatic polyisocyanates, such as poly(isocyanatophenylmethylene), phenylisocyanate, 2,4-toluenediisocyanate, 2,6-toluenediisocyanate, 2,4′-diphenylmethanediisocyanate, 4,4′-diphenylmethanediisocyanate, hexamethylenediisocyanate, isophoronediisocyanate, 1,4-cyclohexanediisocyanate (U.S. Pat. No. 4,661,533, U.S. Pat. No. 4,065,410, U.S. Pat. No. 3,401,180, U.S. Pat. No. 3,454,606, U.S. Pat. No. 3,152,162, U.S. Pat. No. 3,492,330, U.S. Pat. No. 3,001,973, U.S. Pat. No. 3,394,164, U.S. Pat. No. 3,124,605, U.S. Pat. No. 4,108,791) and the like.

Prepolymers may also be employed in the preparation of the foams of the present invention. These prepolymers are prepared by reacting an excess of organic polyisocyanate or mixtures thereof with a minor amount of an active hydrogen-containing compound as determined by the well-known Zerewitinoff test, as described by Kohler in “Journal of the American Chemical Society,” 49, 3181(1927). These compounds and their methods of preparation are well known in the art. The use of any one specific active hydrogen compound is not critical hereto, rather any such compound can be employed in the practice of the present invention.

Preferred isocyanates used according to the present invention include Mondur 489 (Bayer), Rubinate 1850 (ICI), Luprinate M70R (BASF) and Papi 580 (Dow). Isocyanate indices greater than about 200 are preferred, particularly from about 225 to about 325.

In addition to the polyisocyanate, the foam-forming formulation also contains an organic compound containing isocyanate-reactive groups, preferably at least 1.8 or more isocyanate-reactive groups per molecule. Preferred isocyanate-reactive compounds are the polyester and polyether polyols. Such polyester and polyether polyols are described, for example, in U.S. Pat. No. 4,795,763.

Isocyanate reactive compounds include polyols, polyamines, polyacids, polymercaptons (U.S. Pat. No. 4,394,491, U.S. Pat. No. 3,383,351, U.S. Pat. No. 3,652,639, U.S. Pat. No. 3,623,201, U.S. Pat. No. 3,953,393, and U.S. Pat. No. 3,669,413). These compounds could be derived from petroleum based raw materials or renewable resources such as soybean oil, castor oil, linseed oil, tall oil etc (Journal of Polymers and the Environment, Vol. 12, No. 3, July 2004, Page 123).

The polyester polyols useful in the invention can be prepared by known procedures from a polycarboxylic acid or acid derivative, such as an anhydride or ester of the polycarboxylic acid, and a polyhydric alcohol. The acids and/or the alcohols may be used as mixtures of two or more compounds in the preparation of the polyester polyols.

The polycarboxylic acid component, which is preferably dibasic, may be aliphatic, cycloaliphatic, aromatic and/or heterocyclic and may optionally be substituted, for example, by halogen atoms, and/or may be unsaturated. Examples of suitable carboxylic acids and derivatives thereof for the preparation of the polyester polyols include: oxalic acid; malonic acid; succinic acid; glutaric acid; adipic acid; pimelic acid; suberic acid; azelaic acid; sebacic acid; phthalic acid; isophthalic acid; trimellitc acid; terephthalic acid; phthalic acid anhydride; tetrahydrophthalic acid anhydride; pyromellitic dianhydride; hexahydrophthalic acid anhydride; tetrachlorophthalic acid anhydride; endomethylene tetrahydrophthalic acid anhydride; glutaric acid anhydride; maleic acid; maleic acid anhydride; fumaric acid; dibasic and tribasic unsaturated fatty acids optionally mixed with monobasic unsaturated fatty acids, such as oleic acid; terephthalic acid dimethyl ester and terephthalic acid-bis-glycol ester.

Any suitable polyhydric alcohol may be used in preparing the polyester polyols. The polyols can be aliphatic, cycloaliphatic, aromatic and/or heterocyclic, and are preferably selected from the group consisting of diols, triols and tetrols. Aliphatic dihydric alcohols having no more than about 20 carbon atoms are highly satisfactory. The polyols optionally may include substituents which are inert in the reaction, for example, chlorine and bromine substituents, and/or may be unsaturated. Suitable amino alcohols, such as, for example, monoethanolamine, diethanolamine, triethanolamine, or the like may also be used. Moreover, the polycarboxylic acid(s) may be condensed with a mixture of polyhydric alcohols and amino alcohols.

Examples of suitable polyhydric alcohols include: ethylene glycol; propylene glycol-(1,2) and -(1,3); butylene glycol-(1,4) and -(2,3); hexane diol-(1,6); octane diol-(1,8); neopentyl glycol; 1,4-bishydroxymethyl cyclohexane; 2-methyl-1,3-propane diol; glycerin; trimethylolpropane; trimethylolethane; hexane triol-(1,2,6); butane triol-(1,2,4); pentaerythritol; quinitol; mannitol; sorbitol; formitol; α-methyl-glucoside; diethylene glycol; triethylene glycol; tetraethylene glycol and higher polyethyleneglycols; dipropylene glycol and higher polypropylene glycols as well as dibutylene glycol and higherpolybutylene glycols. Especially suitable polyols are oxyalkylene glycols, such as diethylene glycol, dipropylene glycol, triethylene glycol, tripropylene glycol, tetraethylene glycol, tetrapropylene glycol, trimethylene glycol and tetramethylene glycol.

Particularly preferred polyester polyols include Stepanpol PS2352 (Stepan) and Terate 2541 (Hoechst Celanese). Preferred amounts of the polyester polyols are consistent with isocyanate indices greater than 200, preferably between about 225 and 325.

Polyether polyols useful according to the present invention include the reaction products of a polyfunctional active hydrogen initiator and a monomeric unit such as ethylene oxide, propylene oxide, butylene oxide and mixtures thereof, preferably propylene oxide, ethylene oxide or mixed propylene oxide and ethylene oxide. The polyfunctional active hydrogen initiator preferably has a functionality of 2-8, and more preferably has a functionality of 3 or greater (e.g., 4-8).

A wide variety of initiators may be alkoxylated to form useful polyether polyols. Thus, for example, poly-functional amines and alcohols of the following type may be alkoxylated: monoethanolamine, diethanolamine, triethanolamine, ethylene glycol, polyethylene glycol, propylene glycol, hexanetriol, polypropylene glycol, glycerine, sorbitol, trimethylolpropane, pentaerythritol, sucrose and other carbohydrates. Such amines or alcohols may be reacted with the alkylene oxide(s) using techniques known to those skilled in the art. The hydroxyl number which is desired for the finished polyol would determine the amount of alkylene oxide used to react with the initiator. The polyether polyol may be prepared by reacting the initiator with a single alkylene oxide, or with two or more alkylene oxides added sequentially to give a block polymer chain or at once to achieve a random distribution of such alkylene oxides. Polyol blends such as a mixture of high molecular weight polyether polyols with lower molecular weight polyether polyols can also be employed.

Any suitable blowing agent can be employed in the foam compositions of the present invention. In general, these blowing agents are liquids having a boiling point between minus 50° C. and plus 100° C. and preferably between 0° C. and 50° C. The preferred liquids are hydrocarbons or halohydrocarbons such as chlorinated and fluorinated hydrocarbons. Suitable blowing agents include HCFC-141b (1-chloro-1,1-difluoroethane), HCFC-22 (monochlorodifluoromethane), HFC-245 fa (1,1,1,3,3-pentafluoropropane), HFC-134a (1,1,1,2-tetrafluoroethane), HFC-365mfc (1,1,1,3,3-pentafluorobutane), cyclopentane, normal pentane, isopentane, LBL-2(2-chloropropane), trichlorofluoromethane, CCl₂ FCClF₂, CCl₂ FCHF₂, trifluorochloropropane, 1-fluoro-1,1-dichloroethane, 1,1,1-trifluoro-2,2-dichloroethane, methylene chloride, diethylether, isopropyl ether, methyl formate, carbon dioxide and mixtures thereof.

The foams also can be produced using a froth-foaming method, such as the one disclosed in U.S. Pat. No. 4,572,865. In this method, the frothing agent can be any material which is inert to the reactive ingredients and is easily vaporized at atmospheric pressure. The frothing agent advantageously has an atmospheric boiling point of −50° to 10° C., and includes carbon dioxide, dichlorodifluoromethane, monochlorodi fluoromethane, trifluoromethane, monochlorotrifluoromethane, monochloropentafluoroethane, vinylfluoride, vinylidenefluoride, 1,1-difluoroethane, 1,1,1-trichlorodifluoroethane, and the like. A higher boiling blowing agent is desirably used in conjunction with the frothing agent. The blowing agent is a gaseous material at the reaction temperature and advantageously has an atmospheric boiling point ranging from about 10° to 80° C. Suitable blowing agents include trichloromonofluoromethane, 1,1,2-trichloro-1,2,2-trifluoroethane, acetone, pentane, and the like. In the froth-foaming method, the foaming agents, e.g., trichlorofluoromethane blowing agent or combined trichlorofluoromethane blowing agent and dichlorodifluoromethane frothing agent, are employed in an amount sufficient to give the resultant cured foam the desired bulk density which is generally between 0.5 and 10, preferably between 1 and 5, and most preferably between 1.5 and 2.5, pounds per cubic foot.

The foaming agents generally comprise from 1 to 30, and preferably comprise from 5 to 20 weight percent of the composition. When a foaming agent has a boiling point at or below ambient, it is maintained under pressure until mixed with the other components. Alternatively, it can be maintained at subambient temperatures until mixed with the other components. Mixtures of foaming agents can be employed.

Any suitable surfactant can be employed in the foams of this invention, including silicone/ethylene oxide/propylene oxide copolymers. Examples of surfactants useful in the present invention include, among others, polydimethylsiloxane-polyoxyalkylene block copolymers available from Witco Corporation under the trade names “L-5420”, “L-5340”, and Y10744; from Air Products under the trade name “DC-193”; from Goldschmidt under the name, Tegostab B84PI; and Dabco DC9141. Other suitable surfactants are those described in U.S. Pat. Nos. 4,365,024 and 4,529,745. Generally, the surfactant comprises from about 0.05 to 10, and preferably from 0.1 to 6, weight percent of the foam-forming composition.

Additives include surfactant (silicon, phosphorus, fluorine and the like), catalyst (triethyl amine, benzyldimethylamine, triethylenediamine, potassium t-butoxide, sodium borohydride, hydroxides of quarternery nitrogen, sodium formate, sodium benzoate, potassium acetate, calcium diacetate, potassium octoate, N,N-dimethylethanol amine, N-ethylmorpholine, tetramethylbutane diaminecarboxilic salts of tin, zinc, lead, mercury, cadmium, bismuth, antimony, iron, manganese, cobalt, copper, vanadium, and the like), colorants, mold release agent, flame retardant, antioxidants and the like.

Facings for use in the present invention include any flat, sheet material suitable to the required end application of the final board product. At least the upper facer must be flexible enough to be wrapped tightly around a metering roll. Facers must also be flat enough to not significantly alter the small gap between metering rolls. Such materials include aluminum foil/kraft paper laminations, bare aluminum foil, paper roof insulation facings, and coated glass fiber mats. A facer, as used herein, may also include oriented strandboard or gypsum, in which case such rigid material is conveyed to the laminator, and foam-forming mixture is preferably applied directly thereon.

The filler used in the present polyisocyanurate foam composition is talc. The talc is present at a high loading, from 0.5 to 20 wt % based on the isocyanate reactive compounds, and more preferably from 3 to 15 wt %. and most preferably from 5 to 15 wt %. At said high loadings, it is important to have a talc with an average particle size that ranges from 7 to 20μ, more preferably from 7-11μ and most preferably from 7-10μ. The composition provides one with an economical rigid polyisocyanurate foam material that also exhibits excellent, even improved properties.

### EXAMPLE

A wide range of talc particles (Table 1), with or without surface coating, has been evaluated.

TABLE 1
Types of Talc

| | | Average Particle Size | |
|---|---|---|---|
| Filler | Shape | Surface Coated | Un-coated |
| Talc | Leaflets, platelet | 0.8μ (MT AG 609), | 0.8μ (Ultratalc |
| | shaped, lamellar | 3μ (9103S, | 609), |
| | | silane coated) | 3μ (Talc 9103), |
| | | | 7μ (Jetfil 350), |
| | | | 10μ (Talc 9110), |
| | | | 11μ (Jetfil 150) |

Commercially available talc vendors such as Luzenac and Specialty minerals were tested in the laboratory. The average particle sizes of 0.8μ, 3μ and 10μ are from Specialty Minerals while the others are from Luzenac.

In the laboratory experiment low density (˜1.5-17) a free rise foam cup is made at room temperature with the isocyanate index at 250. The fillers are mixed with the polyols along with the other ingredients. Then it is mixed with MDI with stirring to make free rise foam. The foam is cured at room temperature for 24 h and then tested for various properties.

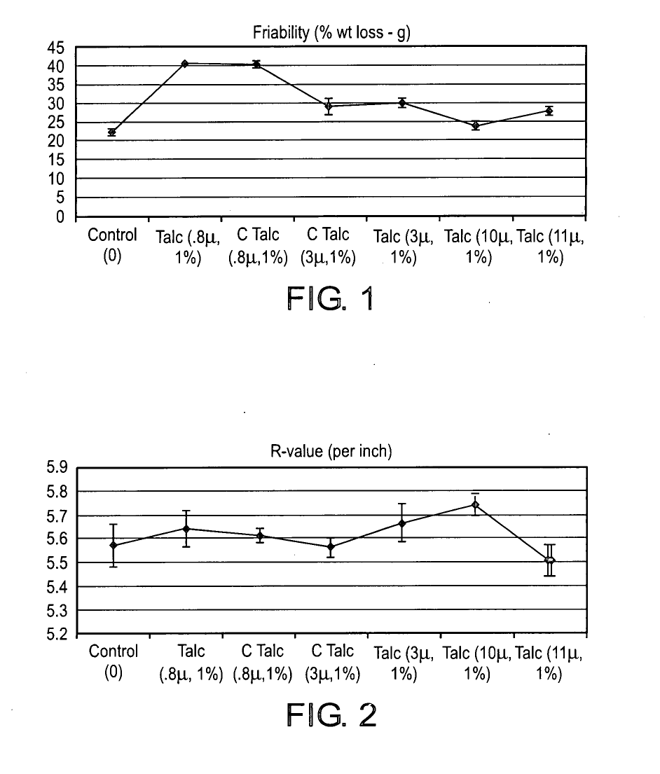

At low percentage (1 wt % in polyol) the effect of filler talc particle size in polyisocyanurate foam physical properties such as CS/D (compressive strength/density), R value (insulation) and PIR/PUR (polyisocyanate/polyurethane ratios analyzed by FTIR spectroscopy) (Table 2) is observed. A significant effect of filler talc particle size on “Friability” has emerged. The effect is minimum or insignificant for the talc of average particle size 10μ (FIG. 1).

TABLE 2
Effect of Talc particle size at 1 wt % in polyols

| | | | | Std | | Std | | Std |
|---|---|---|---|---|---|---|---|---|
| Particle Size (μ) | CS/D | Std Div | R | Div | PIR/PUR | Div | Friability | Div |
| Control with no | 22.65 | 0.97 | 5.57 | 0.09 | 2.31 | 0.057 | 22.18 | 0.71 |
| filler | | | | | | | | |
| 0.8 μ (talc, NC) | 17.99 | 0.07 | 5.64 | 0.21 | 2.37 | 0.06 | 40.19 | 0.15 |
| 0.8 μ (talc, WC) | 17.87 | 0.18 | 5.61 | 0.03 | 2.39 | 0.03 | 40.06 | 0.78 |
| 3 μ (Talc NC) | 21.41 | 0.33 | 5.67 | 0.081 | 2.34 | 0.067 | 27.02 | 1.04 |
| 3 μ (Talc, WC) | 20.30 | 0.21 | 5.56 | 0.04 | 2.3 | 0.06 | 29.04 | 2.23 |
| 10 μ (Talc) | 23.00 | 0.86 | 5.75 | 0.05 | 2.44 | 0.000 | 23.54 | 1.03 |
| 11 μ (Talc) | 20.25 | 0.63 | 5.51 | 0.06 | 2.40 | 0.017 | 27.61 | 0.99 |

WC: with surface coating;
NC: no surface coating;
CS: composite strength (psi);
D = density (pound per cubic feet);
R = thermal resistance (HrFt²F/Btu);
Friablility = % of wt loss per gram.

In FIG. 1, the effect of particle size in Friability at 1 wt % in polyol is shown. The effect of particle size is also significant for polyisocyanurate foam thermal insulation (R-value) properties. These are shown in FIG. 2. Considering the wide range of particle size of filler talc, the average particle size of 10μ appeared to increase the R-value by 3%.

A more significant effect of talc particle sized is observed upon increasing filler loading to 10 wt % or higher in polyols, see Table 3 below.

TABLE 3
5–15 Wt % of Talc in polyols

| | | Std | | Std | | Std | | Std |
|---|---|---|---|---|---|---|---|---|
| Particle Size (μ) | CS/D | Div | R | Div | PIR/PUR | Div | Friability | Div |
| Control with no | 22.65 | 0.97 | 5.57 | 0.09 | 2.31 | 0.057 | 22.18 | 0.71 |
| filler | | | | | | | | |
| 0.8 μ (talc, NC, 15 wt %) | 13.18 | 0.19 | 5.53 | 0.11 | 2.3 | 0.13 | 58.65 | 0.53 |
| 0.8 μ (talc, WC, | 13.19 | 0.63 | 5.35 | 0.06 | 2.35 | 0.07 | 56.07 | 1.19 |
| 15 wt %) | | | | | | | | |
| 3 μ (Talc NC, 5 wt %) | 19.16 | 0.40 | 5.67 | 0.008 | 2.33 | 0.025 | 33.53 | 0.86 |
| 3 μ (Talc, NC, 10 wt %) | 16.67 | 1.04 | 5.61 | 0.028 | 2.41 | 0.038 | 37.23 | 0.94 |
| 3 μ (Talc, NC, 15 wt %) | 15.49 | 0.49 | 5.41 | 0.112 | 2.34 | 0.035 | 42.07 | 0.39 |
| 7 μ (Talc, NC, 5 wt %) | 17.95 | 0.67 | 5.66 | 0.03 | 2.40 | 0.038 | 25.96 | 0.61 |
| 7 μ (Talc, NC, 10 wt %) | 16.83 | 0.44 | 5.66 | 0.01 | 2.46 | 0.061 | 31.07 | 1.06 |
| 10 μ (Talc, NC, 10 wt %) | 18.24 | 0.01 | 5.63 | 0.08 | 2.45 | 0.025 | 35.54 | 0.53 |
| 10 μ (Talc, NC, 15 wt %) | 16.97 | 0.16 | 5.62 | 0.03 | 2.39 | 0.006 | 42.72 | 0.51 |
| 11 μ (Talc, NC, 10 wt %) | 16.35 | 0.20 | 5.46 | 0.07 | 2.39 | 0.052 | 38.57 | 1.77 |
| 11 μ (Talc, NC, 15 wt %) | 15.19 | 0.24 | 5.36 | 0.06 | 2.32 | 0.072 | 41.31 | 0.49 |

WC: with surface coating;
NC: no surface coating;
CS: composite strength (psi);
D = density (pound per cubic feet);
R = thermal resistance (HrFt²F/Btu);
Friablility = % of wt loss per gram.

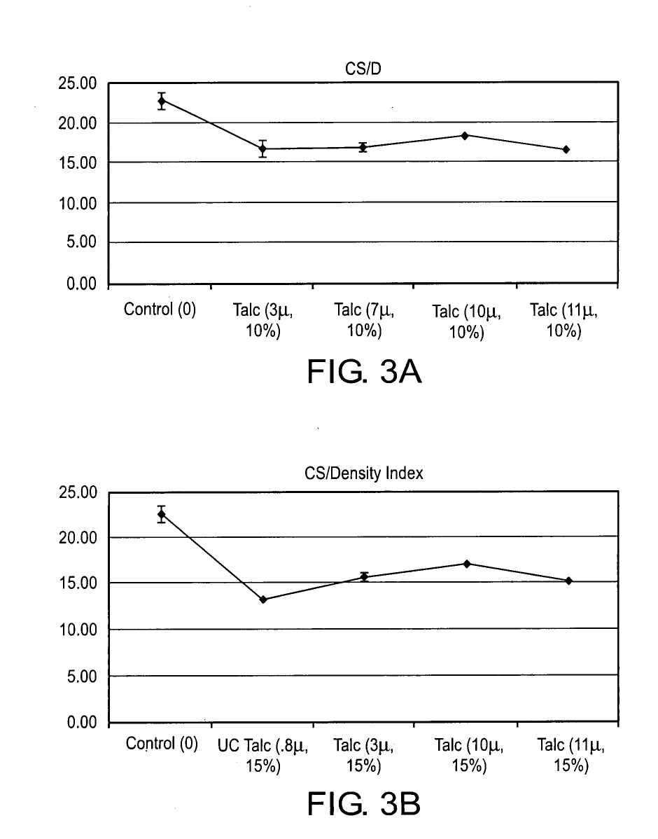

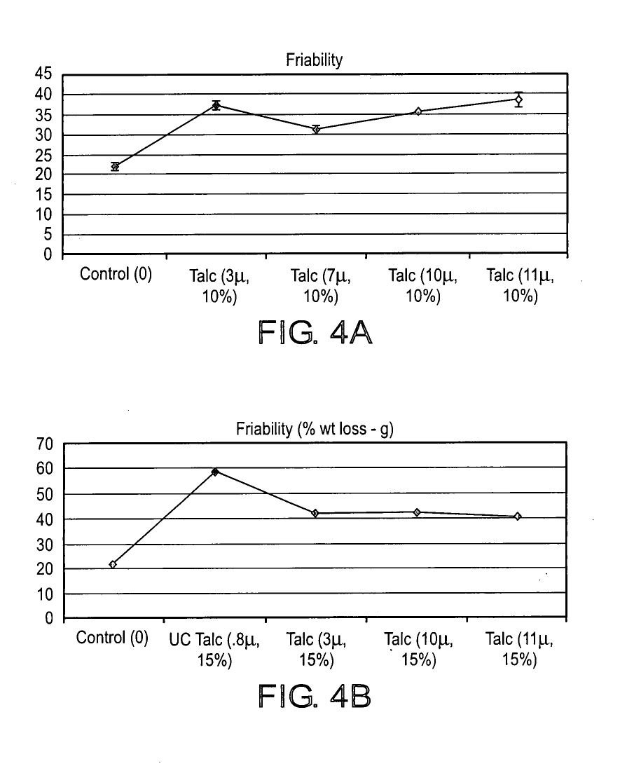

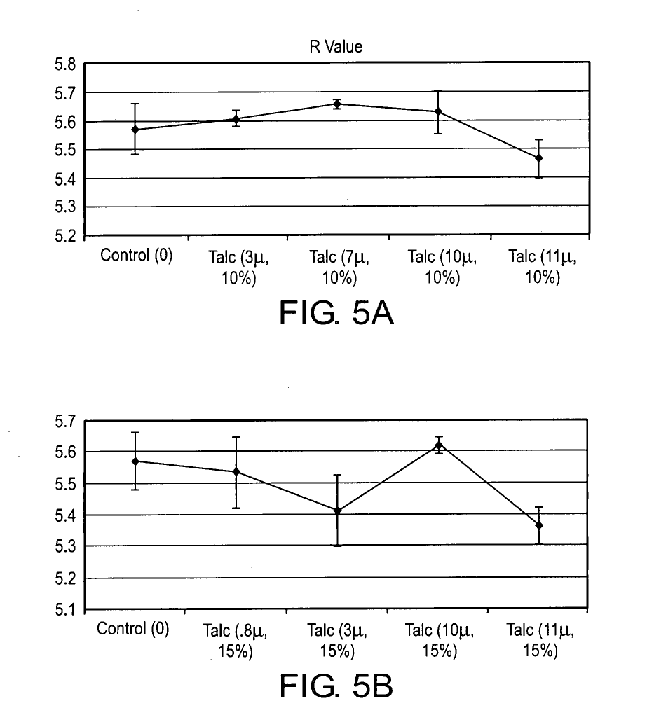

The ratio of compressive strength to density is affected by the particle size of filler talc at high filler loading as shown in FIG. 3. In the filler loading of 10 and 15 wt % level in polyol average particle size of 10μ showed best results. Lowering the average particle size further reduced the ratio of compressive strength to density. In general, the effect of talc particle size is significant for the foam “Friability” property as shown in FIG. 4. The effect is very severe for the smaller sized talc particles. The foam insulation property (R value), see FIG. 5, is also affected by filler talc. The optimum size appeared to be around 7-10μ, with 10μ being preferred.

In summary, the greatest benefits of using talc are observed when the following characteristics are selected:
1. Filler talc shape (any shape such as leaflets, platelet shaped, lamellar) and particle size (≧7μ−≦20μ) in polyisocyanurate foam.
2. Filler talc could be surface coated with e.g., silane, etc. or not surface coated.
3. Loading of talc from 0.5-20 wt % in polyols in polyisocyanurate foam.
4. Improvement of polyisocyanurate foam properties such as thermal insulation, PIR/PUR, etc., at the loading of 0.5-20 wt % of talc in polyol.
5. Statistically significant improvement of polyisocyanurate foam thermal insulation properties by >3% at the loading of 0.5-20 wt % in polyol.
6. Minimum or no reduction of Compressive strength at high filler loading (0.5-20 wt % in polyol).

While the invention has been described in detail and with reference to specific embodiments thereof, it will be apparent to one skilled in the art that various changes and modifications can be made herein without departing from the spirit and scope thereof.

What is claimed is:

1. A polyisocyanurate foam composition comprising an isocyanate reactive compound, a polyisocyanate, blowing agent and talc filler component, wherein the amount of talc filler in the composition ranges from 0.5 to 20 wt % based upon the weight of isocyanate reactive compound, and the particle size of the talc filler ranges from 7μ to 20μ.

2. The composition of claims 1, wherein the amount of talc present in the composition ranges from 3 to 15 wt % based upon the weight of the isocyanate reactive compound.

3. The composition of claim 1, wherein the amount of talc present in the composition ranges from 5 to 15 wt %, based upon the weight of the isocyanate reactive compound.

4. The composition of claim 1, wherein the size of talc filler particles range from 7 to 11μ.

5. The composition of claim 1, wherein the size of the talc filler particles range from 7 to 10μ.

6. The composition of claim 1, wherein the isocyanate reactive compound is a polyol.

7. The composition of claim 1, wherein the talc is uniformly dispersed in the polyisocyanurate foam.

8. The composition of claim 1, wherein the talc is surface coated.

9. A rigid polyisocyanurate foam material prepared from the composition of claim 1.

10. The foam material of claim 9, wherein the material is a foam board.

11. A process for preparing a rigid polyisocyanurate foam material which comprises activating the blowing agent in the composition of claim 1 and controlling the rise of the foam to thereby prepare the foam material.
